(19) United States
(12) Patent Application Publication
(10) Pub. No.: US 2023/0122891 A1
(43) Pub. Date: Apr. 20, 2023

(54) VERTICAL LIFT MODULAR STRUCTURE

(71) Applicant: SencorpWhite, Inc., Hyannis, MA (US)

(72) Inventors: Brett Keller, Catawissa, PA (US); Michael Snyder, New Tripoli, PA (US)

(21) Appl. No.: 17/965,196

(22) Filed: Oct. 13, 2022

Related U.S. Application Data
(60) Provisional application No. 63/255,727, filed on Oct. 14, 2021.

(51) Int. Cl. B65G 1/04; B65G 1/137

(52) U.S. Cl. CPC B65G 1/0464; B65G 1/1373

(57) ABSTRACT

An automated storage and retrieval system that coordinates two or more vertical lift modules, each having an elevator system, into a single vertical lift assembly. A first vertical lift module is positioned next to, and offset vertically from, an independent second vertical lift module. A content transfer section is disposed between the two vertical lift modules that is accessible by the elevator system of each vertical lift module. Alternatively, trays can be transferred directly from one elevator system to another elevator system.

### FIELD

The present disclosure relates to automated storage and retrieval systems. In particular, the present disclosure relates to coordinating independent vertical lift module (VLM) structures to work in conjunction with one another.

### BACKGROUND

A VLM is an automated storage and retrieval device that stores trays of parts or other items in storage locations, for example in trays, and delivers the trays to an operator when requested. The request may be by an electronic inventory management system or by manual input to a machine control system.

For simplicity, the invention will be described as having or using “trays”. “Trays” include any type of storage container, shelf or the like that can hold items and is compatible with the vertical lifts structures disclosed herein

A VLM has an elevator system to allow transfer of trays to and from operator access points and storage locations. The vertical construction reduces the footprint of the storage assembly, providing a high-density storage solution, particularly suitable for use in warehouses, manufacturing sites, distribution facilities and retail locations.

Capacity of conventional VLMs is limited by the number and size of trays that a single elevator can service. Accordingly, there is a need for a VLM with increased capacity, to further reduce the required footprint.

### SUMMARY

An automated storage and retrieval system is presented that coordinates two or more VLMs, each having an elevator system, into a single vertical lift assembly, thereby providing the potential to improve high density storage solutions by increasing efficiency and providing floor space savings. A first VLM is positioned next to, and offset vertically from, an independent second VLM. A tray transfer section is disposed between the two VLMs that is accessible by the elevator system of each VLM. Alternatively, trays can be transferred directly from one elevator system to another elevator system.

In a further embodiment of the automated storage and retrieval system, two or more VLMs are positioned vertically in-line with one another. A tray is transferred between vertically adjacent VLMs, thereby reducing the footprint of the assembly further.

### DESCRIPTION OF DRAWINGS

The detailed description refers to the following accompanying figures, which depict illustrative embodiments of a vertical lift modular system.

FIG. 1A depicts a vertical lift system.

FIG. 1B is an enlargement of a portion of the vertical lift system showing transfer elevators and transfer elevator cars.

FIGS. 2A-2E depict various views of the transfer station 120 shown in FIG. 1B.

FIG. 3 depicts an illustrative tray 124 into which items may be deposited and stored, or from which items may be retrieved in an automated storage and retrieval system comprising VLM components.

FIG. 4 depicts a portion of a belt and pulley system that imparts vertical movement to an elevator car.

FIGS. 5A-5C depict a direct transfer VLM system.

FIG. 6 depicts a simplified, illustrative top view of a vertical lift modular system.

FIGS. 7A-7B depict an in-line VLM system.

FIG. 8 depicts schematic of an illustrative embodiment of a VLM management system.

FIG. 9 is a block diagram of an illustrative embodiment of a computing device that is a component of a VLM system.

### DETAILED DESCRIPTION OF EMBODIMENTS

The figures and descriptions provided herein may have been simplified to illustrate aspects that are relevant for an understanding of the described devices, systems, and methods, disclosed herein while eliminating, for the purpose of clarity, other aspects that may be found in typical devices, systems, and methods. Those of ordinary skill may recognize that other elements or operations may be desirable or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that could be implemented by those of ordinary skill in the art.

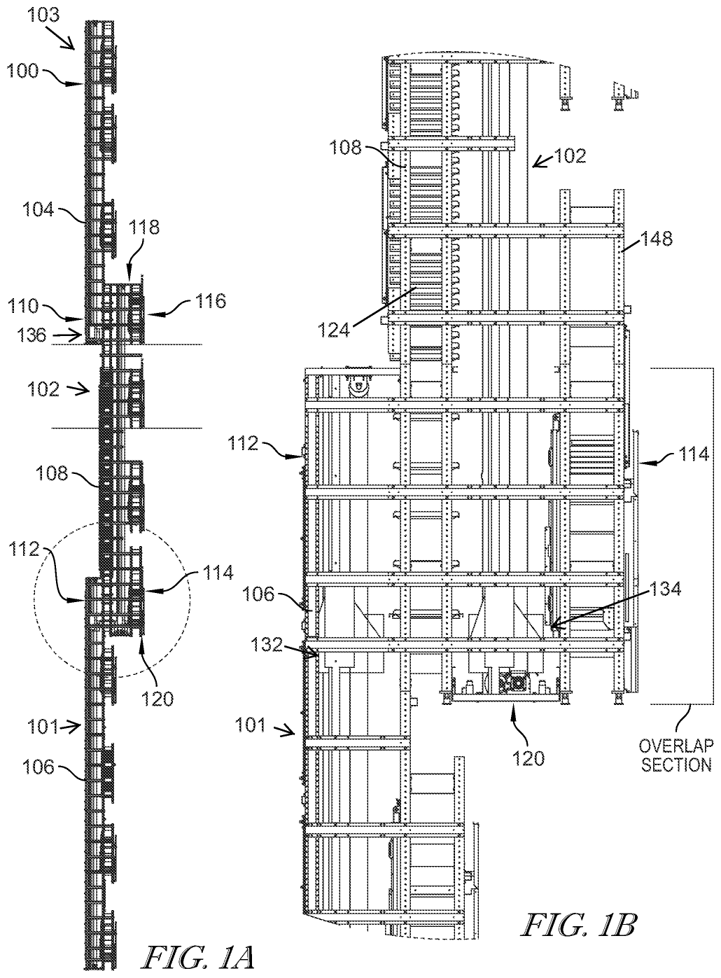

FIG. 1A depicts a vertical lift system 100 having transfer elevators 101, 102, 103. Each transfer elevator has an elevator car 132, 134, 136, respectively. FIG. 1B is an enlargement of a portion of vertical lift system 100 showing transfer elevators 101, 102 and transfer elevator cars 132, 134. Vertical lift system 100 may have multiple independent vertical lift module (VLM) structures, spanning multiple floors of a building. FIG. 1A shows a first VLM 104, a second VLM 106 and a third VLM 108. First VLM 104 and second VLM 106 are co-linear. Third VLM 108 is offset from first VLM 104 and second VLM 106 but functionally connected to each through a first transfer station 118 and a second transfer station 120. Third VLM 108 extends from a lower portion 110 of first VLM 104 to an upper portion 112 of second VLM 106. An upper portion 112 of second VLM 106 is adjacent to a lower portion 114 of third VLM 108, and lower portion 110 of first VLM 104 is adjacent to an upper portion 116 of third VLM 108. The “adjacent” regions may also be referred to as “overlaps.” First transfer station 118 is positioned at the overlap of first VLM 104 with third VLM 108. Second transfer station 120 is disposed at the overlap of second VLM 106 with third VLM 108. Elevator cars 132, 134, 136 are configured to transport items vertically within VLM 104, 106, 108. The specific configuration may depend on the type of item, for example. Elevator car variations may be to the car dimensions, materials, load capacity or other specifications that are required or desirable to transport the items.

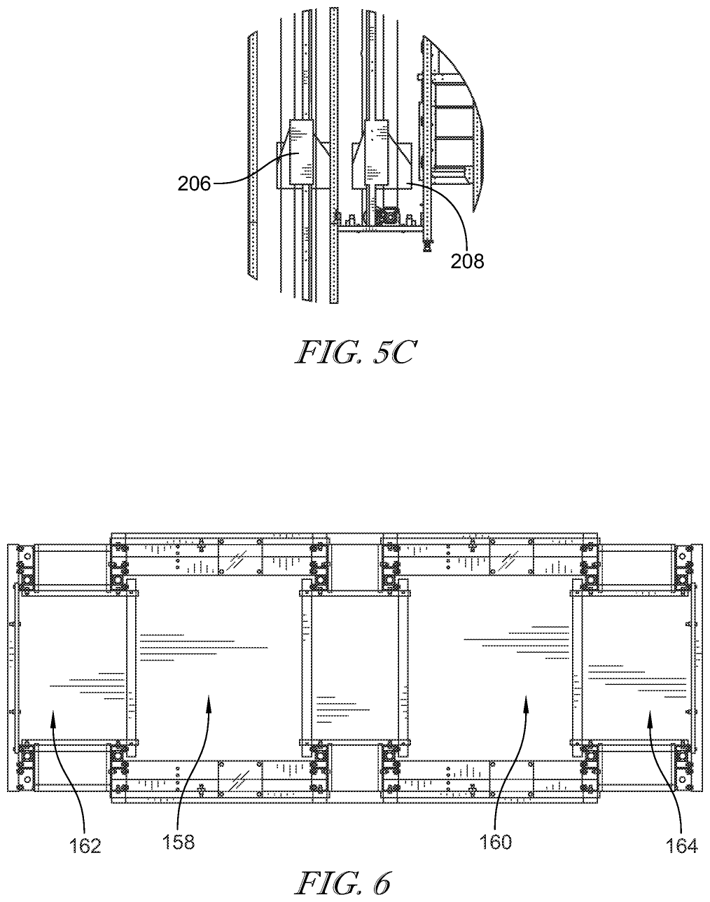

Elevator cars 132, 134, 136 operate within a frame 148. Frame 148 may contain guide rails to eliminate or reduce swaying of the elevator cars. FIG. 6 depicts a simplified, illustrative top view of a VLM system showing two shafts 158, 160 within which elevator cars operate. Shafts 158, 160 are formed by frame 148. Frames may be structures such as shown FIGS. 1A, 1B, for example, or they may be structures such as those forming conventional elevator shafts configured to accommodate elevator cars and operate as described herein. Storage areas 162, 164 are adjacent to shafts 158, 160. Trays 124 are stored in or retrieved from storage area 162, 164. Storage areas may be included on more than one side of shafts 158, 160, provided they do not interfere with operation of the elevators, and provided they are configured to accept and offer trays to retrieval/storage areas of the elevator cars.

Items stored in first VLM 104 may be transferred at first transfer station 118 for conveyance downward through third VLM 108 and then transferred at second transfer station 120 to second VLM 106. VLM 106 may then transport the stored items to a building floor on which a user is located who requested the items. The reverse process may also be implemented to bring items from lower floors to higher floors. It is also possible for a user to request that items be brought to a different floor or to a different user.

Additional staggered VLMs with additional transfer stations at the overlaps of the VLMs may be connected to span more floors of a building. Although the structures are being referred to as being within buildings, they may also be constructed to service exterior areas that can benefit from multiple VLMs extending to heights beyond what a single VLM can service. Appropriate shafts configured for the locations would be implemented.

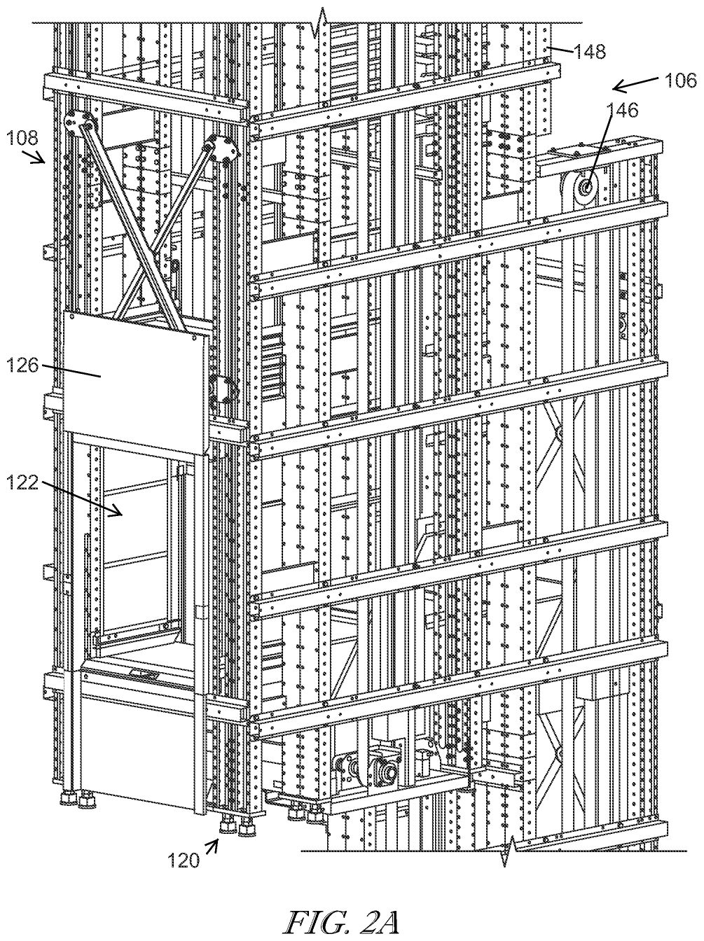

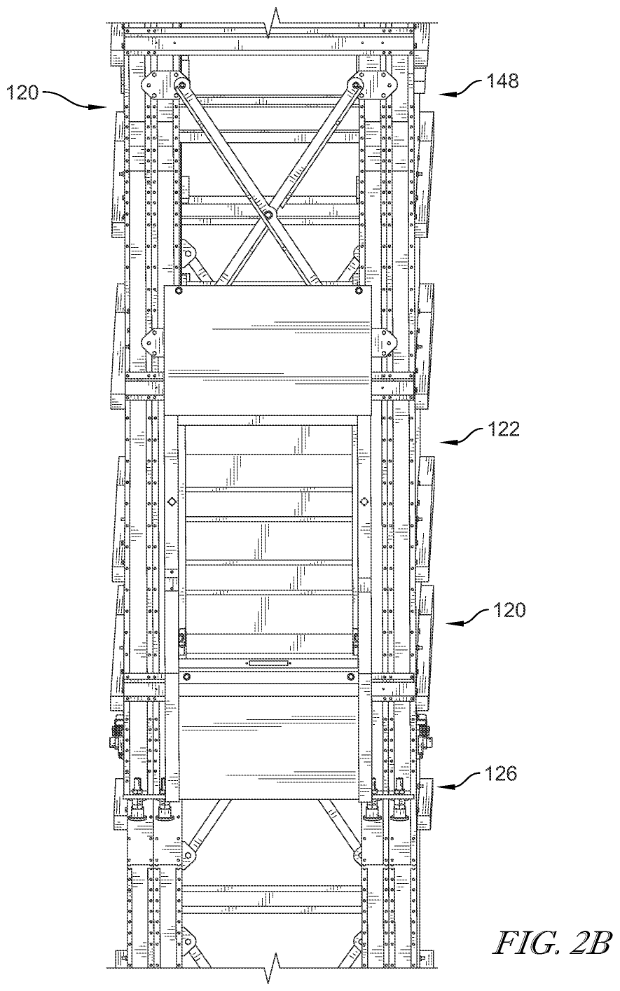

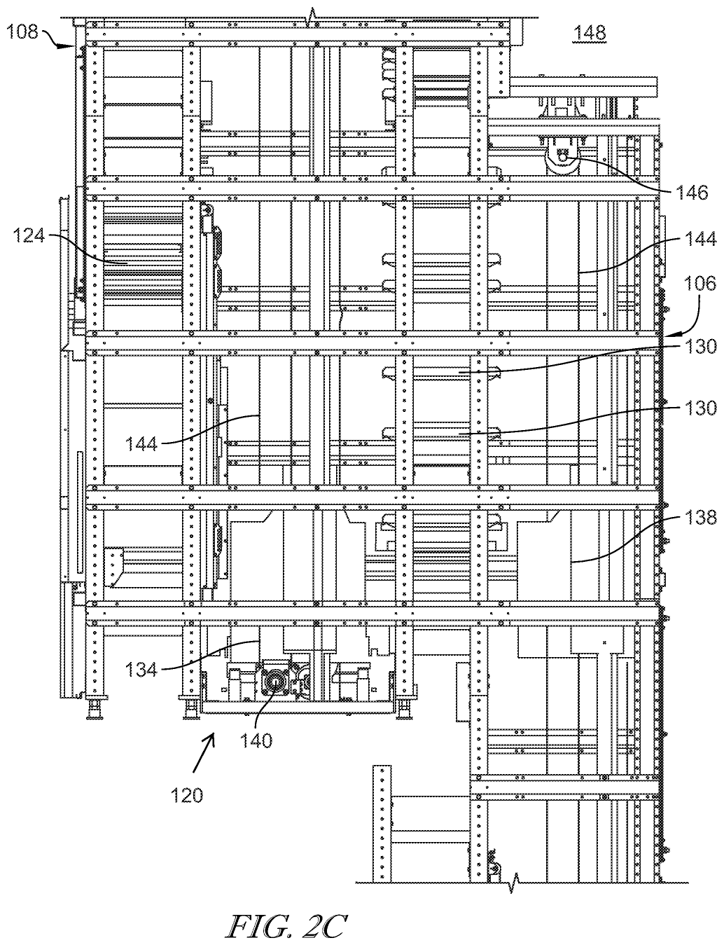

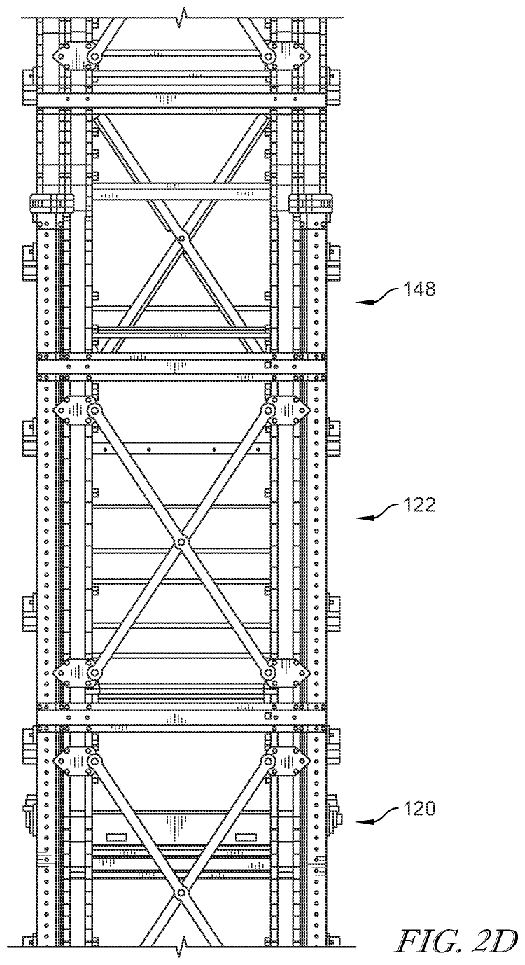

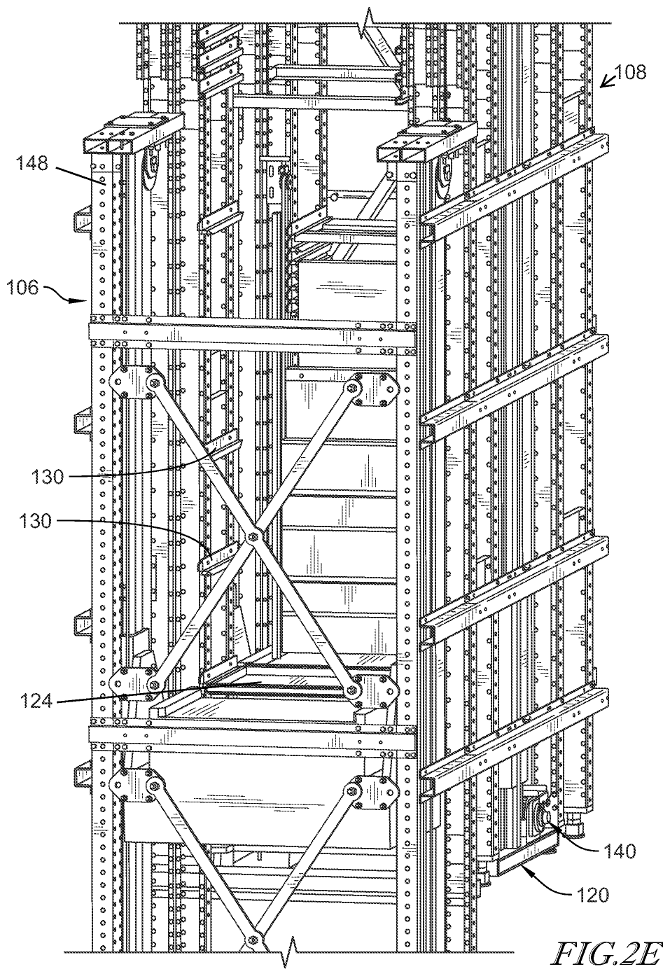

FIGS. 2A-2E depict various views of transfer station 120 shown in FIG. 1B. FIG. 2A is an isometric view showing the front and a first side of transfer station 120, i.e. the side opposite the side shown in FIG. 1B. FIG. 2B is a front view of transfer station 120. FIG. 2C is a full side view of the side shown in FIG. 2A, depicting transfer station 120. FIG. 2D is a back view of transfer station 120. FIG. 2E is an isometric view showing the rear and second side of transfer station 120.

FIG. 2A shows an access opening 122 positioned so a user can insert or withdraw items from a tray 124, such as depicted in FIG. 2E. VLM system may have multiple access openings 122. Each may have an access door 126. In an illustrative embodiment of a vertical lift system, a computer display is positioned at access opening 122, for example on a stand nearby, or integrated with the VLM or surrounding wall or support system. An access door 126 opens upon arrival of an elevator car 134 (depicted in FIG. 1B) for removal of requested items from tray 124 or placement of items to be stored in tray 124. The opening of access door 126 may be automatic upon arrival of tray 124, or may be opened by a user, either manually or by activating it electronically. A security code, password, RFID or other security mechanism may be employed to gain access to the contents of tray 124. A “pick-to-light” mechanism may be employed, wherein a part of the tray containing the items requested is illuminated to help a user identify the desired items. Once items are removed from or placed in a tray, the user may close access door 126 either manually or electronically, as designed. The user can direct further movement of tray 124 within VLM system 100, through a computer system programmed to obtain input from a user, scanned labels, or other sources or input device, and execute movement of the items to appropriate locations based on the input. In general, a storage location may be selected by a user, or the tray or items in the tray may be coded for automatic identification of, and delivery to or removal from a storage location.

In an illustrative example of the operation of VLM system 100, tray 124 is stored in first VLM 104. A user at an access opening 122 at a lower floor serviced by VLM 106 inputs a request to retrieve items stored in tray 124. Tray 124 is automatically withdrawn from its storage location by use of linear motors to impart horizontal motion, for example. Upon removal from its storage location, tray 124 enters an elevator car 136 in first VLM 104. Elevator car 136 descends VLM 104 to first transfer station 118. At first transfer station 118, tray 124 is again moved horizontally, but this time to an elevator car 134 in third VLM 108. Elevator car 134 transports tray 124 vertically through third VLM 108 to second transfer station 120. Vertical movement may be effectuated, for example, by a belt and pulley system activated by a motor. Traditional elevator technology may be used to operate elevator car 134, and other elevators in VLM system 100. Tray 124 is now moved horizontally, for example, by a linear motor, to an elevator 138 in second VLM 106. Elevator car 132 in elevator 138 descends through second VLM 106 to an access opening 122 corresponding to the location to which the items are directed to be delivered by the user input. Items may be introduced into, or removed from, VLM system 100 through one or more access openings 122. Uniquely, trays are transferred horizontally between two or more VLMs as opposed to merely being transferred in and out of a single VLM.

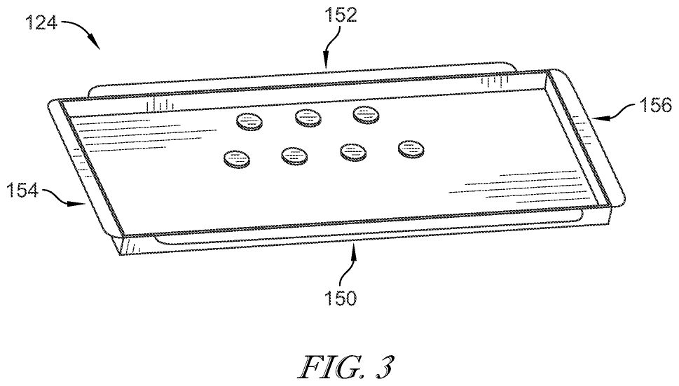

FIG. 3 depicts an illustrative tray 124 into which items may be deposited and stored, or from which items may be retrieved. In this illustrative embodiment, tray 124 has opposing flanges 150, 152 on the longer sides. Tray 124 also has flanges 154, 156 on opposing, shorter sides. Flanges 150, 152 can engage with guides in transfer stations 118, 120 to enable trays 124 to transfer from a VLM to the transfer station and then to another VLM. They may also engage with guides in VLMs 104, 106 for storage. Flanges 152, 156 engage with tray tracks 130 (see FIG. 2E) for storage within a VLM.

In general, trays are compatible with storage areas, elevators and transfer mechanisms that transfer the trays or items within them between any of those system components. For example, a tray will need to be compatible with a storage area so that it may be transferred to and from the storage area and be maintained in the storage area without human intervention.

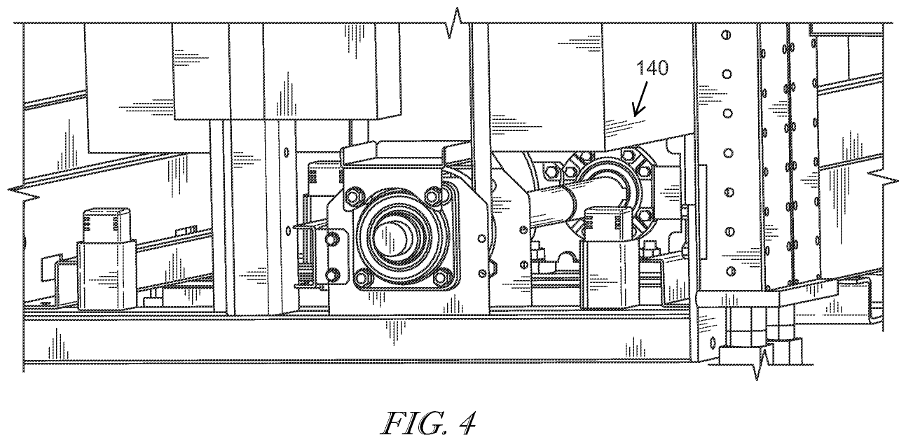

FIG. 4 depicts a portion of a belt and pulley system that imparts vertical movement to an elevator car 132, 134, 136. A motor 140 generates rotational motion to drive pulley 142 to drive belt 144 (see FIB. 2C). Drive belt 144 is further disposed around an idler pulley 146, such as the one shown in FIGS. 2A, 2C. Each elevator system has a belt and pulley system to run an elevator car 132, 134, 138 up and down the corresponding VLM. The belt and pulley system may include belts and pulleys on opposing sides of elevator car 132, 134, 136. In an illustrative embodiment, a VLM has four pulleys associated with each elevator, two at the bottom and two at the top. These include two drive pulley and two idler pulleys.

A controller, for example an electronic control unit, controls motors 140 to operate movement of elevator cars 132, 134, 138 according to user or automated input and programmed algorithms. Upon reaching a destination according to instructions input to the controller, a signal is sent to the controller to stop the elevator car. Doors to access openings may be configured to only open upon user request, or may automatically open when the elevator car arrives at a destination.

The controller may include an interactive electronic control system that is coordinated with embodiments of the multiple-elevator VLM system. A multi-media workstation provides an input device, such as a touch screen or keypad for entry of information and instructions. The control system governs picking and refilling operations, and may also include inventory management, software and devices. For example, bar code or QR code readers, scanners or other devices that can identify and track items moving through, in and out of the VLM system can be incorporated to provide inventory information, such as quantities and locations, for example. Control software may operate a multiple-elevator VLM or a plurality of single VLMs.

The controller may be a single unit or comprise multiple control components. The controller may have a single processor or multiple processors. The controller may monitor movement of elevator cars 132, 134, 138 and actions, such as user access, and item or tray removal or onboarding. Signals are sent to the controller by a user via a user interface, or by a sensor, or other signal-generating device. Signals are processed by the controller according to its programmed processor, and an output is generated. The output is directed, for example to an actuator that produces the movement of the VLM or components thereof, such as access door 126, elevator cars 132, 134, 136, 138, tray retrieval mechanisms and other movements of the system that are not, manually operated.

Retrieval of items and delivery to storage locations may take place according to the order in which requests are input. Alternatively, priorities may be programmed into the controller so that certain retrieval requests are taken out of order. An urgency level may be established and assigned to prioritize retrieval or storage. For example, in a retail setting, an item needed for a customer on sight may be prioritized over items being retrieved for shipment. In a service or maintenance setting, a vehicle or machine that has been taken out of service and needs to be returned to operation as soon as possible could be assigned a high priority. The controller may also be programmed to carry out retrieval and storage requests based on optimizing the elevator cars' travel times or distances. A controller may be configured to implement a combination of these procedures according to programmed algorithms.

Each VLM is installed in a shaft, such as by welding brackets into the shaft walls. The shaft may also be within an open frame. A shaft, particularly one within a building, is designed with fire control mechanisms to inhibit fire from travelling vertically through a building, for example, by using fire barrier construction, shaft wall liners, floor isolation techniques, or other fire and smoke containment methods and systems. The fire control mechanisms are configured to be compatible with the vertical lift system, for example by allowing transfer of trays between VLMs, while maintaining suitable fire control. Fire barriers in transfer stations can control the spread of fire from one level to another. For example, a transfer station can be isolated from VLMs above and below it by fire walls including temporary closure of interfaces between transfer stations and VLMs.

Embodiments of the multiple-elevator VLM may be constructed to achieve various throughput rates, and store and retrieve various weight loads. Multi-elevator VLMs may be built to accommodate trays of different dimensions and load capacity.

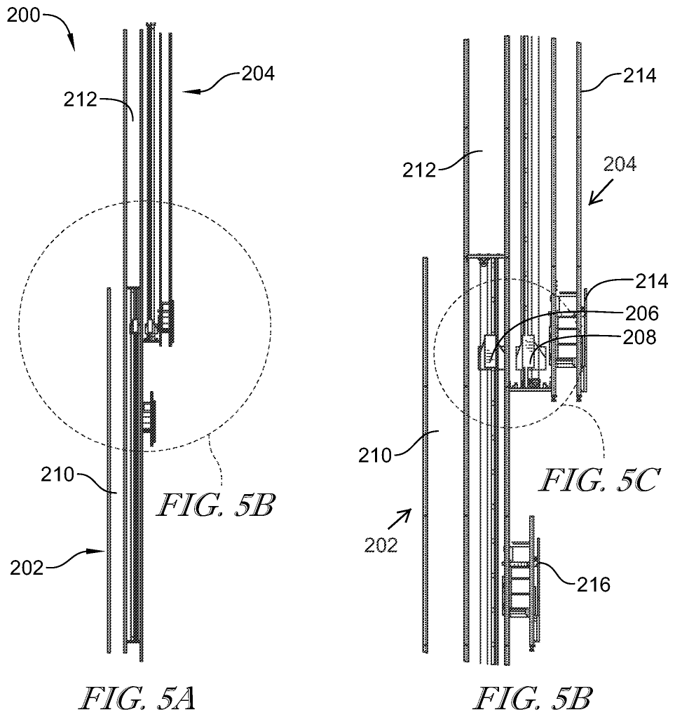

FIGS. 5A-5C depict a direct transfer VLM system 200. FIG. 5B is an enlargement of a portion if FIG. 5A. FIG. 5C is a further enlargement of a portion of that portion of FIG. 5A. Trays 124 are transferred directly from a first VLM 202 to a second VLM 204. VLM reference numbers used for parts of VLM system 200 are different than some of those used for VLM system 100, however, the systems, parts and methods can be analogous, except for changes to the transfer section in VLM system 200. A tray 124 is transported in an elevator car 206 in first VLM 202, and is transferred to an elevator car 208 in second VLM 204. During the transfer, elevator car 206 and elevator car 208 must be aligned horizontally. This differs from VLM system 100, which allows a first elevator car to deposit a tray 124 at a transfer station location to await arrival of a second elevator car to which tray 124 will be transferred. VLM system 100 allows the first elevator to rise or descend for other tasks while the second elevator becomes available to retrieve the tray from the transfer station. Therefore, VLM system 100 may avoid or reduce idle elevator time as compared to direct transfer VLM system 200. Advantageously though, direct transfer VLM system 200 has a smaller relative footprint as compared to VLM system 100.

First VLM 202 and second VLM 204 have storage areas 210, 212, respectively. First VLM 202 and second VLM 204 each have one or more access openings 216, 214, respectively, positioned so a user can insert or withdraw items from a tray 124. In an illustrative embodiment of the vertical lift system, a computer display is positioned at access openings 214, 216 such as on a stand nearby, or integrated with the VLM or surrounding wall or support system. An access door, for example one analogous to access door 126, opens upon arrival of elevator cars 206, 208 for removal of requested items from tray 124 or placement of items to be stored in tray 124. Access door 124 may open automatically upon arrival of tray 124, or may be activated by a user, either manually or by activating it electronically. A security code, password, RFID or other security mechanism may be employed to gain access to the contents of tray 124. A “pick-to-light” mechanism may be employed, wherein a part of the tray containing the items requested is illuminated to help a user identify the desired items. Once items are removed from or placed in a tray, the user may close the access door either manually or electronically, as designed. The user can direct further movement of tray 124 within VLM system 200 through a computer system programmed to obtain input from a user, scanned labels, or other sources or input device, and execute movement of the items to appropriate locations based on the input. In general, a storage location in VLM 202, 204, or other VLM, may be selected by a user, or the tray or items in the tray may be coded for automatic identification of, and delivery to or removal from a storage location.

In an illustrative example of the operation of VLM system 200, tray 124 is stored in first VLM 204. A user at an access opening 214 at a lower floor serviced by VLM 202 inputs a request to retrieve items stored in tray 124. Access opening 214 can be the same or similar to access opening 136 of VLM system 100. Tray 124 is automatically withdrawn from its storage location, for example by use of linear motors to impart horizontal motion. Upon removal from its storage location, tray 124 enters an elevator car 208 in first VLM 204. Elevator car 208 descends VLM 204, to a position horizontal from elevator car 206, or stops and waits for elevator car 206 to arrive at a position horizontal to elevator car 208. Once elevator car 208 is in line horizontally with elevator car 206, tray 124 is moved horizontally, for example by one or more linear motors directly from elevator car 208 to elevator car 206. Once tray 124 has been transferred, elevator car 206 may descend to access opening 216 for retrieval of items by the user.

In a further illustrative example, a user at an access opening 216 at a lower floor serviced by first VLM 202 calls for elevator car 206. Once elevator car 206 is at access opening 216, the user places items into a tray 124. Elevator car 206 may have an access door that opens automatically upon arrival, can be manually opened by a user, or electronically opened by a user. The user directs VLM system 200 to deliver the items in tray 124 to a storage location or to another user at a different location. Alternatively, the tray or item in the tray can be identified by the system, for example by a sensor or scanner, and the system software will direct the item or tray to a particular storage location. If the storage location or other user is at a floor not serviced by elevator car 206, elevator car 206 moves to a position in an overlap (transfer) area of VLM 202 and VLM 204. Once elevator car 206 and elevator car 208 are positioned horizontally from one another in the overlap area, tray 124 is directly transferred from elevator car 206 to elevator car 208. Elevator car 208 then begins its ascent through VLM 204 to the location or user to which tray 124 has been directed.

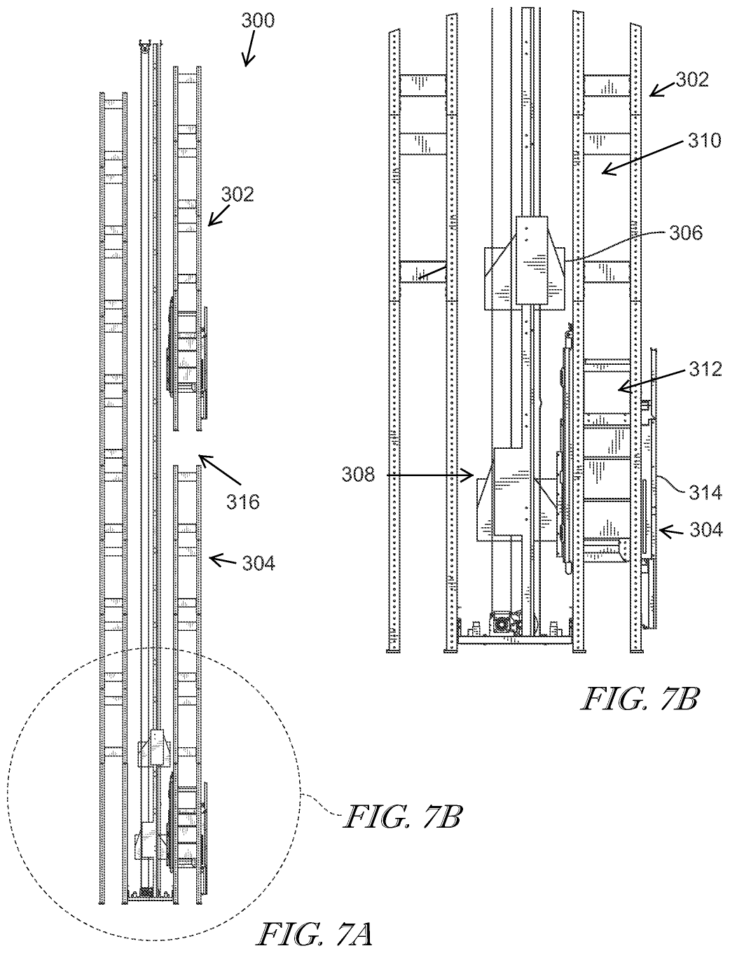

The aforementioned processes can apply to vertical lift system 100 shown in FIGS. 1A, 1B, the direct transfer vertical lift system depicted in FIGS. 5A, 5B and the in-line VLM system depicted in FIGS. 7A, 7B, with trays being transferred as described with respect to each of those embodiments.

As with VLM system 100, direct transfer VLM system 200 and in-line VLM system 300 may utilize traditional elevator technology to operate elevator cars 206, 208 and any other elevator cars in the system. The elevator technology may also be adapted or customized for the VLM systems, for example, dimensions, load capacity, environment and use.

FIGS. 7A, 7B depict an in-line VLM system 300. VLM system 300 has a first VLM 302 and a second VLM 304. FIG. 7B is an enlargement of a portion of FIG. 7A. VLM 302 and VLM 304 are vertically in line with one another.

VLM 302 and VLM 304 have elevator cars 306, 308, respectively. Storage areas 310, 312, are provided along at least a portion of the length of VLM 302, 308, respectively. Each of VLM 302, 304 has access openings 314, 316, respectively.

A tray 124 may be transferred directly, or indirectly between VLM 302 and VLM 304. A tray 124 is transported in elevator car 306 in first VLM 302, and is transferred to an elevator car 308 in second VLM 304. During the transfer, elevator car 306 and elevator car 308 remain aligned vertically. This differs from VLM systems 100 and 200 in which elevator cars are offset from one another. Elevator cars 306, 308 are configured to transfer items or trays to and from one another. This can be accomplished via openings in the tops and bottoms of elevator cars 306, 308. In a further illustrative embodiment, elevator cars 306, 308 have cross-sections and dimensions smaller than cross-sectional dimensions of a VLM, thereby allowing them to be adjacent, vertically to one another to allow transfer of trays or items from one elevator car to another. In yet a further embodiment, a single car travels within multiple VLMs as a conventional elevator can travel within a single shaft to multiple floors.

In a further illustrative embodiment, VLM 302 and VLM 304 are aligned vertically, and transfer of trays takes place vertically. Although the transfer is described as being vertical, components of the apparatus may move horizontally to accomplish the transfer. For example, a transfer center may be incorporated into the system, which would accept horizontally shifted trays from a first VLM. The transfer center could then move the tray vertically to a position that would allow the tray to be transferred horizontally to a second VLM. Thus, the transfer center would be offset from the vertical line in which the VLMs are stacked.

VLM 302 and VLM 304 may differ from one another in structure or dimensions to facilitate operation of each VLM in an in-line configuration and transfer of trays or other contents between first VLM 302 and second VLM 304. However, VLM 302 and VLM 304 may have the same structure, or substantially the same structure.

In an illustrative embodiment of vertical lift system 300, like in vertical lift systems 100, 200, a computer display is positioned at access openings 314, 316 such as on a stand nearby, or integrated with the VLM or surrounding wall or support system. An access door, for example one analogous to access door 126, opens upon arrival of elevator cars 306, 308 for removal of requested items from tray 124 or placement of items to be stored in tray 124. Access door 124 may open automatically upon arrival of tray 124, or may be activated by a user, either manually or by activating it electronically. A security code, password, RFID or other security mechanism may be employed to gain access to the contents of tray 124. A “pick-to-light” mechanism may be employed, wherein a part of the tray containing the items requested is illuminated to help a user identify the desired items. Once items are removed from or placed in a tray, the user may close the access door either manually or electronically, as designed. The user can direct further movement of tray 124 within VLM system 200 through a computer system programmed to obtain input from a user, scanned labels, or other sources or input device, and execute movement of the items to appropriate locations based on the input. In general, a storage location in VLM 302, 304, or other VLM, may be selected by a user, or the tray or items in the tray may be coded for automatic identification of, and delivery to or removal from a storage location.

A method of controlling a vertical lift assembly is disclosed. The method comprises a machine readable storage medium containing executable code to carry out any of the methods described herein; a system having one or more processors; a memory coupled to a processor; and an output device connected to the processor(s) to control one or more VLMs according to embodiments described herein.

A non-transitory computer readable medium is also disclosed. The non-transitory computer readable medium has computer executable instructions stored thereon executed by a processor to perform the methods of controlling and using the vertical lift assemblies described herein.

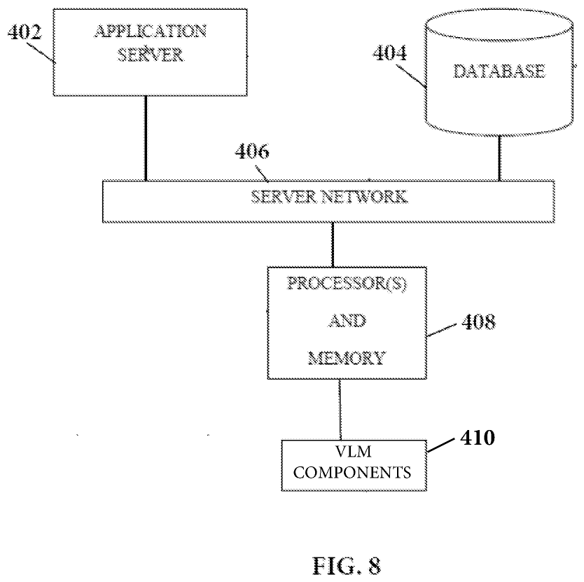

FIG. 8 depicts schematic of an illustrative embodiment of a VLM management system. Although not depicted, the system can operate in the Cloud, including software and databases being stored therein. The system may be interfaced with various software applications, including for example, a warehouse management system, or order picking system for further automation and inventory management, for example. The VLM management system may manage the flow of items into, out of and within the VLM system. An application server 402 and a database 404 are connected to a server network 406. Applications that control the VLM system act on input generated, for example by a user via a keyboard, display screen or other input device or user interface, scanners reading barcodes or QR codes. The software applications are executed by one or more processors 408. Memory required for execution of the applications that can store algorithms and data is represented in block 408. The VLM management system operates movement of components 510 of the VLMs, including transfer stations, and movement of items into, out of and within the VLM system, such as by actuating pulley systems and motors that drive the elevator cards and tray movement from a VLM to a transfer station or the reverse. In addition, the VLM management system can keep track of inventory amounts, distribution, locations and replenishment needs. The VLM management system can be configured to recognize inventory taken from and introduced into the system, for example through scanners or user input or a combination thereof. Software can be executed that processes the inventory information to provide user desired information such as inventory levels, distribution and location, for example. The VLM may be managed without human intervention for all or part of the processes. By Internet or cloud connectivity the VLM management system can be integrated with other systems and applications.

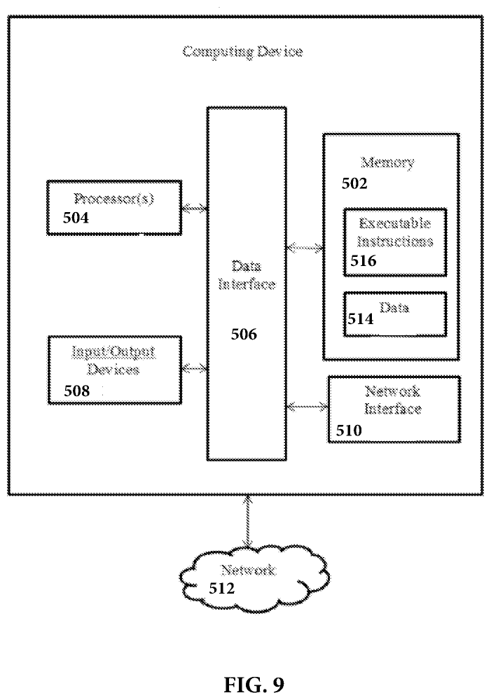

FIG. 9 is a block diagram of an illustrative embodiment of a computing device that is a component of a VLM system. Computing device 500 comprises a memory device 502 that may be a single memory device or multiple devices for storing executable code 516 to implement any portion of operating or utilizing the VLM system to distribute, store and retrieve items, including algorithms, for example inventory management algorithms. Further contained in memory device 502 may be stored data 514, for example inventory data or information on particular items and inventory requirements. One or more processors 504 are coupled to memory device 502 by a data interface 506. Processor 504 may be any device(s) configured to execute one or more applications and analyze and process data according to methods used to employ automated system 100 for its intended use. Processor 204 may be a single processor or a plurality of processors acting individually or in unison. Processor 504 may be, for example, a microprocessor, an application specific processor, or other device that may process and transform electronic data. Processor 504 executes the instructions stored on memory device 502. Memory device 502 may be integrated with processor 504 or be a separate device. Illustrative types and features of memory device 502 include volatile and/or non-volatile memory. Various types of memory may be used, provided the type(s) are compatible with the system and its functions. Illustrative examples of memory types include, but are not limited to, various types of random access memory, static random access memory, read only memory, magnetic disk storage devices, optical storage media, and flash memory devices.

Input/output devices 508 are coupled to data interface 506. This may include image capture devices, scanners, actuators, keyboards and/or touch screens, for example. A network interface 510 is also shown coupled to data interface 506, which may couple the computing device components to a private or public network 512.

An illustrative communications architecture for a VLM system may include software associated with the VLM system that provides functionality such as movement of elevator cars in a VLM system, inventory management, data management and supervisory system software. A supervisor station is provided from which an operator can interface with the VLM system and its software and hard components. Software applications to control movement of the VLM system and information management and coordination with any other integrated systems and software. One or more scanners, for example obtaining information as input for various software applications.

Software applications can communicate to middleware, for example, via TCP/IP messaging. The middle ware translates the data to and from a programmable logic controller (PLC). The software application(s) can message to and from the PLC to ensure proper integration of VLM system components.

The middleware can be linked to one or more servo motors to operate the elevators and other moving parts of the VLM system.

Human-machine interfaces for operation of the VLM system allow operators to interface with the system to provide information or instructions if not accomplished automatically.

The communications architecture for a VLM system also includes input-output devices. These may include, for example, scanners, touch screens, or touchless devices for registering input from a user and outputting signals to the system. A display server can coordinate with various displays in the VLM system.

In addition to configurations described and shown herein, aspects of conventional elevator shaft and car technology may be implemented in the vertical lift systems, configured for automated storage and retrieval of parts and other items.

As used herein, a “shaft” may have solid walls that encase an elevator car, or may be a more open structure, such as the framework shown in FIGS. 1, 5, 7. Typically, within a building, the shaft will comprise solid walls except at points such as access opening. This may be necessary for safety and fire control reasons. A motor or hydraulic system may be used to impart movement to an elevator car along guide tracks within a shaft.

Vertical lift modular structures described herein may solve problems encountered when implementing such structures in multi-floor buildings or buildings with large vertical space. For example, belts that engage the pulleys have a limit to their length, thereby limiting the height of a vertical lift module. Additionally, wiring to motors may be limited as to length. The vertical lift structures described herein may transport items for storage and retrieval over larger vertical distances than conventional vertical lift structures, thereby overcoming obstacles inherent in those structures.

Various embodiments of storage and retrieval systems have been described herein, each having a different combination of elements. The invention is not limited to the specific embodiments disclosed, and may include different combinations of the elements disclosed, omission of some elements or the replacement of elements by the equivalents of such structures.

Claimed is:

1. A vertical lift assembly comprising:
a plurality of vertical lift mechanisms contained in a frame;
the frame defining a first shaft, a second shaft and a transfer section disposed between the first shaft and the second shaft;
a first elevator having a first elevator car configured for operation in the first shaft;
a second elevator having a second elevator car configured for operation in the second shaft;
the first elevator car configured to retrieve and deliver storage trays from a first storage section;
the second elevator car configured to retrieve and deliver storage trays from a second storage section; and
the first elevator car and the second elevator car configured to accept and deliver storage trays from and to the transfer section.

2. The assembly of claim 1 wherein the system is a co-linear system comprising:
a first VLM co-linear with a second VLM; and
a third VLM offset from the first VLM and the second VLM and functionally connected to each through a transfer station.

3. The assembly of claim 1 wherein the assembly is a direct transfer VLM system.

4. The assembly of claim 1 wherein the assembly is an inline VLM system.

5. The assembly of claim 1 having multiple independent VLMs configured to span multiple floors of a building.

6. The assembly of claim 2 having additional staggered VLMs with additional transfer stations at the overlaps of the VLMs.

7. The assembly of claim 1 having a controller to control the VLMs, including associate motors and executing algorithms for delivery of items to be stored and retrieval of stored items.

8. The assembly of claim 7 wherein the delivery and retrieval of items take place according to the order in which requests are input.

9. The assembly of claim 7 wherein the delivery and retrieval of items take place according to priorities entered or programmed into the controller so that retrieval requests may be taken out of order.

10. The assembly of claim 9 wherein priority is based on an urgency level.

11. The assembly of claim 9 wherein priority is based on optimization of the elevator cars' travel times or distances.

12. The assembly of claim 1 having fire-control mechanisms.

13. A vertical lift assembly comprising:
a plurality of vertical lift mechanisms contained in a frame;
the frame defining one or more shafts;
the one or more shafts vertically in-line with one another;
one or more elevator cars configured for operation in the one or more shafts; and
the one or more elevator cars further configured to transfer contents to another of the one or more elevator cars.

14. The vertical lift assembly of claim 13 wherein the shaft comprises two or more adjacent vertical shafts.

15. A method of controlling a vertical lift assembly comprising:
a machine readable storage medium containing an executable code to carry out any of the methods described herein;
a system having one or more processors;
a memory coupled to a processor;
an output device connected to the processor(s) to control one or more VLMs according to embodiments described herein.

16. A non-transitory computer readable medium with computer executable instructions stored thereon executed by a processor to perform the methods of controlling and using the vertical lift assemblies described herein.
